(19) United States
(12) Patent Application Publication
(10) Pub. No.: US 2011/0259574 A1
(43) Pub. Date: Oct. 27, 2011

(54) ADJUSTABLE HEAT EXCHANGER

(75) Inventors: John H. Angel, Pittsburgh, PA (US); Gregory G. Homoki, Allison Park, PA (US)

(73) Assignee: ALSTOM TECHNOLOGY LTD, Baden (CH)

(21) Appl. No.: 12/766,269

(22) Filed: Apr. 23, 2010

(51) Int. Cl. G05D 23/00; F28F 9/00

(52) U.S. Cl. 165/287; 165/157

(57) ABSTRACT

Disclosed herein is a novel, adjustable heat exchanger 100 for reliably exchanging heat from a hot working fluid to a transfer fluid. The working fluid passes through an inlet plenum 110, at least one conduit 133 that may be a tube or a plurality of tubes, and out of an outlet plenum 150. A chamber wall 132 encloses the conduits 133 creating a central chamber 130 having interstitial spaces 139 around the conduits 133. A transfer fluid passes through the interstitial spaces in a direction substantially opposite the working fluid, absorbing heat from the conduits 133. A bypass 180 fluidically connects the transfer fluid source 170 to central chamber 130 proximate the inlet plenum 110. Cool transfer fluid bypasses a portion of the central chamber and is provided directly to the central chamber 130 proximate the inlet plenum 110 to cool structures there and reduce heat failures, while providing a constant flow of transfer fluid out of the heat exchanger 100.

### BACKGROUND

1. Field of the Invention

This disclosure relates to a device that exchanges heat from one fluid to another, and more specifically to a to a device that exchanges heat from one fluid to another that is more reliable and effective compared with the prior art.

2. Discussion of Related Art

Typically heat exchangers are fixed surface devices that passively process multiple streams of gases/liquids/solids. Heat is transferred from the hot working fluid stream to the cooler transfer fluid stream by means of conduction, convection or radiation. Since they are passive devices, when the streams change temperature, flow or composition, then the performance of the heat exchanger changes as well.

In many processes it is desirable to have some level of control of the heat exchanger performance. This can sometimes be accomplished by varying the input flow of either fluid, by introducing recirculation flows or dilution by another fluid to one fluid stream or the other. If the input flows of the fluids are improperly varied, there is the risk of providing less fluid than is required for cooling portions of the heat exchanger, thereby “starving” the heat exchanger of needed cooling leading to overheating and premature failure of the heat exchanger. This is often the result of providing a complete bypass. All of the transfer fluid bypasses a portion of the heat exchanger through external piping or ducts routing it from the inlet to the outlet piping.

A common use of these heat exchangers is for preheating air for combustion in furnaces. The hot flue gases from combustion (the working fluid) are provided to a working fluid inlet of a heat exchanger and pass through to a working fluid outlet.

Inlet air (transfer fluid) enters the heat exchanger at a lower temperature and absorbs heat as it passes through the heat exchanger. The transfer fluid is typically air that is preheated prior to entering a combustion chamber of a furnace. Since furnaces may operate at different capacities, conventional passive heat exchangers transfer varying amount of heat from the flue gases to the transfer fluid. It is desirable to have the ability to adjust the functioning of the heat exchanger to heat the transfer fluid to a desired temperature, regardless of the current operating capacity of the furnace.

Typical flue gas temperatures at the heat exchanger inlet are 1500-1800 deg. F. These are at the upper limit of temperatures that most metals can withstand. The inlet of the heat exchanger operates at these temperatures continuously as long as the furnace, or other hot fluid source, operates. This eventually causes failure of the metal and also failure of the heat exchanger. Therefore, it is the goal to reduce the temperature of the heat exchanger structures or parts subject to overheating failure, primarily those structures or parts in contact with the hot flue gases, or other hot fluid entering the heat exchanger.

One potential way to reduce the flue gas input temperature is to recirculate cooler flue gases exiting the heat exchanger and mixing them into the hotter gases exiting the furnace so a lower temperature mixture of flue gases go back into the inlet of the heat exchanger. However, this may require refractory lined or stainless steel ducts, high temperature dampers and valves that lead to additional costs.

When recirculation or dilution is employed, there is the complication of an additional circulation fan/pump. The extra flow through the heat exchanger means higher pressure drops, and correspondingly higher power costs to overcome the losses.

Currently, there is a need for a more reliable and adjustable heat exchanger.

### SUMMARY

The present invention may be embodied as a heat exchanger 100 for reliably exchanging heat from a hot working fluid to a transfer fluid. The heat exchanger has an inlet plenum 110 to receive the working fluid and an outlet plenum 150 adapted to collect and expel the working fluid. At least one conduit which may be one or more tubes 133 connect the inlet plenum 110 to the outlet plenum 150. A central chamber 130 is created by a chamber wall enclosing the tubes 133. The central chamber 130 has interstitial spaces 139 around the tubes.

There is a chamber inlet 134 through the chamber wall 132 proximate the outlet plenum 150. There is also a chamber outlet 136 through the chamber wall 132 proximate the inlet plenum 110. Transfer fluid is provided from a transfer fluid source 170 through the chamber inlet 134, through the interstitial spaces 139 and out the chamber outlet 136 in a direction substantially opposite that of the working fluid. There is a bypass outlet 183 through the chamber wall 132 proximate the inlet plenum 110, and more distal from the outlet plenum 150. This will be intermediate between inlet 134 and outlet 136. A bypass 180 is fluidically connecting the transfer fluid source 170 to the bypass outlet 183, adapted to direct the transfer fluid into the central chamber 130 proximate the inlet plenum 110, to cool the heat exchanger 100 proximate the inlet plenum 110 to reduce heat failures.

The invention may also be embodied as a heat exchanger 100 for reliably exchanging heat from a hot working fluid to a transfer fluid. The heat exchanger has an inlet plenum 110 to receive the working fluid and an outlet plenum 150 adapted to collect and expel the working fluid. At least one conduit 133 that may be a tube or a plurality of tubes 133 connects the inlet plenum 110 to the outlet plenum 150. A central chamber 130 is created by a chamber wall enclosing the tubes 133. The central chamber 130 has interstitial spaces 139 around the tubes.

There is a chamber inlet 134 through chamber wall 132 proximate the outlet plenum 150. There is also a chamber outlet 136 through the chamber wall 132 proximate the inlet plenum 110. Transfer fluid is provided from a transfer fluid source 170 through the chamber inlet 134, through the interstitial spaces 139 and out the chamber outlet 136 in a direction substantially opposite that of the working fluid. There is also a plurality of bypass outlets 183 through the chamber wall 132 each proximate the inlet plenum 150. A plurality of bypasses 180 each fluidically connect the transfer fluid source 170 to one of the bypass outlets 183. This allows the transfer fluid to bypass a portion of the central chamber 130 and cool structures proximate the inlet plenum 110 to reduce heat failures.

The present invention may also be embodied as a method of reducing heat failure in a heat exchanger 100 that transfers heat from a working fluid to a transfer fluid.

The method includes receiving the hot working fluid at an inlet plenum 110 of said heat exchanger 100, passing the working fluid through a heat exchanger 100 out of an outlet plenum 150. Transfer fluid is provided from a transfer fluid source 170 through a chamber inlet 134, the central chamber 130, and out a chamber outlet 136 in a direction opposite that of the working fluid to transfer heat from said working fluid to said transfer fluid. Some or all of the transfer fluid may be directed from the transfer fluid source 170 through a bypass outlet 183 located proximate the inlet plenum 110, and out of the chamber outlet 136 to cool the heat exchanger parts proximal to inlet plenum 110 thereby reducing heat failure and providing a generally constant flow of transfer fluid out of the heat exchanger 100.

### BRIEF DESCRIPTION OF THE DRAWINGS

With reference now to the FIGURES:

FIG. 1 is a perspective view of one embodiment of an adjustable heat exchanger according to the present invention.

### DETAILED DESCRIPTION OF THE PREFERRED EMBODIMENTS

As described above, conventional heat exchangers adjust transfer fluid temperature by changing flow rate of either the first or transfer fluid. This can reduce efficiency. For example, if the hot working fluid is a flue gas stream from a furnace and the cold transfer fluid is an air stream intended to be routed into the combustion chamber of the furnace, adjusting the temperature by controlling the flow of flue gas or of combustion air causes a less than optimum performance of the furnace. There is a defined amount of flue gas produced, and a defined optimum amount of combustion air used.

The means to minimize overheating of the heat exchanger is by employing an interstage bypass of the heated transfer section of the heat exchanger. A portion of the cool transfer fluid inlet stream is allowed to bypass a section of the heat exchanger, and then it is re-introduced into an upper section of the heat exchanger. By this means there is full flow of the transfer fluid over the hottest end of the heat transfer surface. The full flow of the transfer fluid consists of the mixed flow of the unheated bypass stream of transfer fluid and the heated flow stream of transfer fluid passing through the interstitial spaces of the central chamber. The temperature of the mixed stream will be lower than the heated stream and this lower temperature combined with full flow provides greatly improved cooling of the heat exchanger structures that would otherwise be subject to overheating and failure.

In order to permit temperature control, fluid flow is regulated by the use of dampers and/or valves. A single control damper/valve in the bypass line will offer turndown of the heat exchanger's performance, but it is limited by the self-balancing of the pressure drops in the bypass duct and the bypassed portion of the heat exchanger. By adding a second regulating damper/valve at a transfer fluid inlet, the pressure drop through the bypassed portion of the heat exchanger can be adjusted as well. This permits higher bypass flow, and correspondingly a greater reduction of the transfer fluid temperature.

The present invention offers a means to regulate heat transfer from the working fluid (flue gas) to the transfer fluid (combustion air) without the use of additional fans/pumps, without exotic materials, without higher pressure drops, while maintaining safe operating temperatures. Reduction of transfer fluid temperature can be achieved without starving the heat exchanger of cooling flow in critical areas.

The present invention employs simple bypass feature that keeps the transfer fluid flow constant, but can adjust its temperature without modifying the flue gas flow through the heat exchanger.

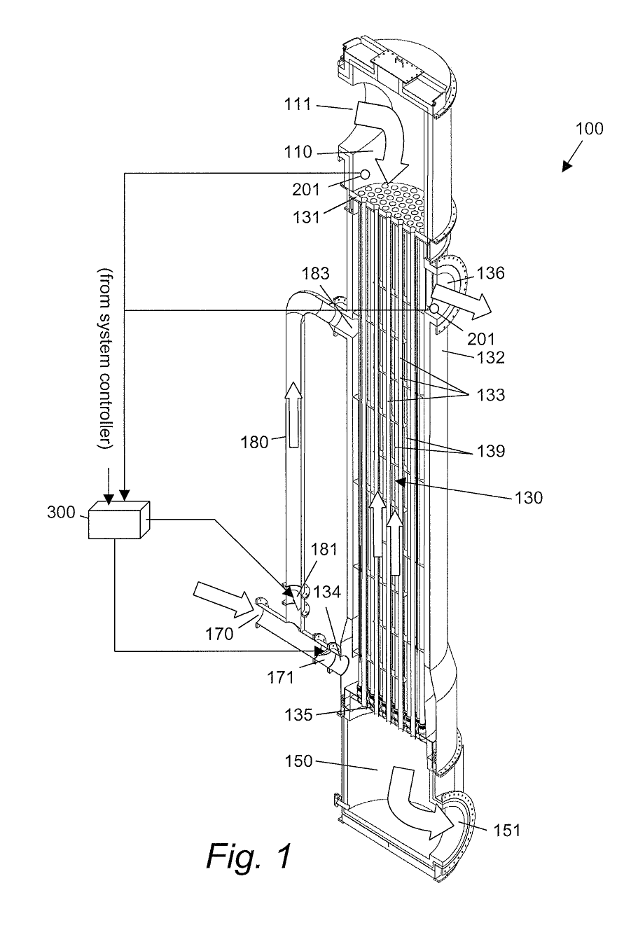

FIG. 1 is a perspective view of one embodiment of an adjustable heat exchanger 100 according to the present invention.

The device has three major sections, an inlet plenum 110, a central chamber 130 and an outlet plenum 150. The inlet plenum 110 is separated from the central chamber by an upper tube plate 131.

The outlet plenum 150 is separated from the central chamber 130 by a lower tube plate 135. A plurality of tubes 133 connect the inlet plenum 110 to the outlet plenum 150. The tubes are held by the upper tube plate 131 and the lower tube plate 135. The plates 131 135 seal around the tubes to separate central chamber 130 from the inlet plenum 110 and the outlet plenum 150. This creates interstitial spaces 139 around the tubes 133 inside of central chamber 130. Therefore, flue gases may flow through a working fluid inlet 111 and into an inlet plenum 110. The upper tube plate 131 stops the gases from passing through the interstitial spaces 139. The flue gases then pass through each of the tubes 133 to the outlet plenum 150 and out of working fluid outlet 151.

A second (cooler) fluid enters the interstitial spaces 139 through a chamber inlet 134 at the lower section of the central chamber 130. The transfer fluid flows through the interstitial spaces 139 around tubes 133, absorbing heat from the flue gases passing through the tubes 133 in the opposite direction. This creates a counter current heat exchange arrangement.

The transfer fluid passes upward until it reaches and exits through the chamber outlet 136.

The present invention also employs a transfer fluid bypass 180 connecting the transfer fluid source 170 to interstitial spaces 139 near a bypass outlet 183. Bypass outlet 183 is near the top of the central chamber 130 and proximate the chamber outlet 136. When transfer fluid passes through the bypass 180, it experiences less heat transfer than the fluid that passes through the interstitial spaces 139. The unheated transfer fluid passing though the bypass 180 will be cooler and mix with the heated transfer fluid that has passed through the interstitial spaces 139, cooling the transfer fluid mixture in the interstitial spaces before approaching the inlet plenum 110 and before it exits the chamber outlet 136. All of the structures near the working fluid inlet 111 and the top of central chamber 130 are also cooled by the lower temperature of the transfer fluid from the bypass 180 and also by the full flow of the transfer fluid mixture, also at a lower temperature than it would be otherwise.

This is important since, as described above, the continuous intense heat, especially at or near inlet plenum 110, causes high temperature or overheating failures such as creep rupture and thermal fatigue of the heat exchanger 100.

Providing cool transfer fluid to the top of the central chamber 130 has a significant impact on reducing overheating and failures.

A bypass valve 181, controls the amount of transfer fluid passing through bypass 180, thereby controlling the amount of cooling of the transfer fluid.

A regulating valve 171 may also be present between the transfer fluid source 170 and the chamber inlet 134. This controls the flow of transfer fluid through the interstitial spaces 139.

By adjusting the bypass valve 181 to adjust the amount of flow passing to the top of central chamber 130, the amount of cooling may be adjusted. Any flow not passing through the bypass 180 flows through the transfer fluid source 170 thereby keeping the total flow of transfer fluid to, and out of heat exchanger 100 unaffected by the bypass adjustment.

In an optional embodiment, one or more temperature sensors are located near the top of central chamber 130. Also, bypass valve 181 and regulating valve 171 are of a type that may be remotely controlled by another device. A controller 300 is connected to at least one sensor 201, the bypass valve 181 and the regulating valve 171. In this embodiment, sensor 201 is located in chamber outlet 136; however, one or more heat sensors may be at other locations for other embodiments. It may also optionally be connected to a larger system controller, such as one that operates a furnace.

Controller 300 will receive information from the system controller indicating a desired temperature of the transfer fluid as it exits chamber outlet 136. Controller 300 also monitors the temperature from at least one of the sensors 201, and then actuates the bypass valve 181 and the regulating valve 171 to produce the desired temperature of transfer fluid at the chamber outlet 136, while minimizing the temperature of the top of central chamber 130 to reduce failures of the heat exchanger 100.

The controller 300 may operate in several different modes. In one mode, it may be provided with a desired temperature. The controller then adjusts the bypass valve 181 and the regulating valve 171 to cause the temperature monitored by the temperature sensor 201 to approximate the desired temperature.

Additionally, controller 300 may be provided with, or have prestored a maximum temperature. It will then adjust the bypass valve and the regulating valve to insure that the maximum temperature does not exceed the maximum temperature.

This is designed to be simple and reliable due to the lack of significant additional machinery. This can result in maintenance and costs savings over many years of use.

Optionally, there may be a plurality of baffle plates 137 in the interstitial spaces 139 for enhancing heat exchange.

Other embodiments of the novel heat exchanger 100 fall under the spirit and scope of the present invention. For example, it may be beneficial to use several bypasses that all lead to inside of the central chamber 130 near the top of the central chamber 130, thereby increasing the amount of transfer fluid that may bypass at least a portion of the central chamber 130. Each of these bypasses may be individually operated thereby adjusting the amount of transfer bypassed.

If the bypass outlets 183 and a corresponding temperature sensor 201 are arranged at various locations within the heat exchanger 100, it is possible for controller 300 to sense the temperature at a given temperature sensor 201 and control a bypass valve 181 corresponding to a given bypass outlet 183 near that temperature sensor 201. This allows for the device to selectively cool hotter areas and extend the usable life of the heat exchanger 100.

The diameter of the bypass may also be modified to adjust the amount of transfer fluid to bypass part of the central chamber 130.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A heat exchanger for reliably exchanging heat from a hot working fluid to a transfer fluid that comprises:
an inlet plenum adapted to receive the working fluid;
an outlet plenum adapted to collect and expel the working fluid;
at least one conduit connecting the inlet plenum to the outlet plenum,
a chamber wall enclosing the conduits creating a central chamber having:
interstitial spaces around the conduits and within the chamber wall;
a chamber inlet being an aperture through chamber wall proximate the outlet plenum;
a chamber outlet being an aperture through the chamber wall proximate the inlet plenum,
a transfer fluid source adapted to provide transfer fluid through the chamber inlet, through the interstitial spaces and out the chamber outlet;
a bypass outlet being an aperture through the chamber wall proximate the inlet plenum;
a bypass fluidically connecting the transfer fluid source to the bypass outlet, adapted to direct the transfer fluid into the central chamber proximate the inlet plenum, to cool the heat exchanger proximate the inlet plenum to reduce heat failures.

2. The heat exchanger of claim 1, further comprising:
a bypass valve adapted to regulate flow of the transfer fluid between the transfer fluid source and the bypass outlet.

3. The heat exchanger of claim 1, further comprising regulator valve adapted to regulate flow of the transfer fluid through the chamber inlet.

4. The heat exchanger of claim 1, further comprising:
a plurality of baffle plates within the interstitial spaces of the central chamber in contact with the conduits adapted to transfer heat between the conduits to the transfer fluid passing though the interstitial spaces.

5. The heat exchanger of claim 1, wherein the valves can be actuated by a controller and further comprising sensors and a controller wherein controller is adapted to:
receive a maximum temperature;
monitor temperature measured by sensor,
adjust bypass valve and regulator valve to keep the temperature measured by sensor below the maximum temperature.

6. The heat exchanger of claim 5 wherein controller is further adapted to:
receive a desired temperature;
adjust bypass valve and regulator valve to keep the temperature measured by sensor as close to the desired temperature without exceeding to exceed the maximum temperature.

7. A method of reducing heat failure in a heat exchanger that transfers heat from a working fluid to a transfer fluid comprising the steps of:
receiving the hot working fluid at an inlet plenum of said heat exchanger;
passing the working fluid through at least one conduit of a heat exchanger and out of an outlet plenum;
providing said transfer fluid from a transfer fluid source through a chamber inlet, the central chamber, and out a chamber outlet in an direction opposite that of the working fluid to transfer heat from said working fluid to said transfer fluid; and
directing any portion of transfer fluid from the transfer fluid source through a bypass outlet located proximate the inlet plenum, and out of the chamber outlet to cool the plenum reduced heat failure and providing a generally constant flow of transfer fluid out of the heat exchanger.

8. The method of claim 7 further comprising the step of:
providing a bypass valve; and
employing the bypass valve to regulate flow of the transfer fluid through the bypass outlet.

9. The method of claim 7 further comprising the step of:
providing a regulator valve; and
employing the regulator valve to regulate flow of the transfer fluid from the transfer fluid source through the chamber inlet.

10. The method of claim 7 further comprising the step of:
providing a plurality of baffle plates within the central chamber in contact with the conduits to transfer heat between the conduits to the transfer fluid passing though the central chamber.

11. The method of claim 7, further comprising the steps of:
providing at least one sensors adapted to measure temperature near the inlet plenum;
providing a bypass valve;
providing a regulating valve;
monitoring temperature measured by sensor,
adjusting the bypass valve 181 and regulator valve to keep the temperature measured by sensor below a predetermined maximum temperature.

12. A heat exchanger for reliably exchanging heat from a hot working fluid to a transfer fluid that comprises:
an inlet plenum adapted to receive the working fluid;
an outlet plenum adapted to collect and expel the working fluid;
a plurality of conduits connecting the inlet plenum to the outlet plenum,
a chamber wall enclosing conduits creating a central chamber around the conduits;
a chamber inlet to the central chamber 130 being an aperture through chamber wall proximate the outlet plenum;
a chamber outlet being an aperture through the chamber wall proximate the inlet plenum,
a transfer fluid source adapted to provide transfer fluid through the chamber inlet, the central chamber and out the chamber outlet;
a plurality of bypass outlets each being an aperture through the chamber wall each proximate the inlet plenum;
a plurality of bypasses each fluidically connecting the transfer fluid source to one of the bypass outlets, to bypass a portion of the central chamber and cool structures proximate the inlet plenum to reduce heat failures.

13. The heat exchanger of claim 12, further comprising:
at least one bypass valve within a bypass adapted to regulate flow of the transfer fluid through a bypass.

14. The heat exchanger of claim 12, further comprising:
at least one regulator valve adapted to regulate flow of the transfer fluid from the transfer fluid source through the chamber inlet.

15. The heat exchanger of claim 12, further comprising:
a plurality of baffle plates within the central chamber in contact with the conduits adapted to transfer heat between the conduits to the transfer fluid passing though the central chamber.

16. The heat exchanger of claim 12, wherein the valves can be actuated by a controller and further comprising sensors and a controller wherein controller is adapted to:
receive a maximum temperature;
monitor temperature measured by the sensors,
adjust at least one bypass valve and regulator valve to keep the temperatures measured by sensor below the maximum temperature.

17. The heat exchanger of claim 12 wherein controller is further adapted to:
receive a desired temperature;
adjust at least one bypass valve and regulator valve to keep the temperatures measured by sensors as close to the desired temperature without exceeding a predetermined maximum temperature.
